(19) United States
(12) Patent Application Publication
(10) Pub. No.: US 2011/0232507 A1
(43) Pub. Date: Sep. 29, 2011

(54) FRUIT JUICER

(76) Inventors: Yoram Aharonovitch, Haifa (IL); Lea Aharonovitch, Haifa (IL)

(21) Appl. No.: 13/156,369

(22) Filed: Jun. 9, 2011

Related U.S. Application Data
(63) Continuation-in-part of application No. 12/515,431, filed on May 19, 2009.

(30) Foreign Application Priority Data
Dec. 4, 2006 (IL) 179806

(51) Int. Cl. A23N 1/02

(52) U.S. Cl. 99/501

(57) ABSTRACT

A fruit juicer comprising: a motor for providing a source of rotary motion; and a juicing tree insertable into a fruit or into a mixing container. The juicing tree comprises: a rotatable shaft, operably couple-able to the motor; at least one flexible juicing branch, extending from the shaft; and at least one cutting tool disposed along the shaft or along the at least one flexible juicing branch. In some embodiments the juicer comprises a temperature measurement mechanism for measuring the temperature of juice being processed by the juicer.

### CROSS-REFERENCE TO RELATED PATENT APPLICATIONS

This application claims priority from Israel patent application IL 179806, entitled “Fruit Juicer” and filed on Dec. 4, 2006. This application is a continuation in part of prior U.S. application Ser. No. 12/515,431, entitled “Fruit Juicer” and filed May 19, 2009, which was a national stage entry of International application PCT/IL2007/001491, entitled “Fruit Juicer” and filed on Dec. 4, 2007, the entire contents of which are incorporated herein by reference.

### FIELD OF THE INVENTION

The present invention relates to fruit juicers, in particular to motor-driven juicers.

### BACKGROUND OF THE INVENTION

Fruit juice is a popular and healthy beverage consumed daily by millions of people. Due to taste and health reasons, many prefer to drink fresh squeezed juice and prepare (squeeze) juice in their homes. However, juicers designed for this purpose, whether manually operated or motor-driven, may contribute to a mess and have several parts to clean, which tends to make them inconvenient and reduces their use.

Enzymes and vitamins in fruits are affected by several factors, including light and/or oxygen and/or temperature. Enzymes are proteins that are required for catalyzing nearly all biological reactions in the body's cells. The activity of most enzymes tends be maximum at about human body temperature. Elevated temperatures can cause enzyme to denature whereby they no longer function.

Vitamin C, for example, is readily oxidized and quite sensitive to light, oxygen and heat. The concentration of vitamin C in food decreases with time in proportion to storage, preparation/processing and cooking temperature.

It is believed that the following publications represent the relevant art with respect to the present invention: US 2009/162,508 (Davies) Fruit corer and juice extracter; U.S. Pat. No. 5,445,068 (Michelson) Apparatus and method for extracting juice from citrus fruits; U.S. Pat. No. 5,157,836 (Aulbers) Tool for separating a core, a rind and a flesh of a fruit, in particular a pineapple; U.S. Pat. No. 4,889,044 (Rosenfield) Fruit juice extractor straw; U.S. Pat. No. 2,807,205 (Gilman) Fruit juicers; U.S. Pat. No. 2,766,792 (Potter) Pressure juice extractor; U.S. Pat. No. 2,746,379 (Covington) Fruit juice extracter; U.S. Pat. No. 2,743,750 (Wilson) Fruit juicer having a corer member and rotable blades; U.S. Pat. No. 2,575,584 (Cohen) Apparatus for extracting juices from citrus fruits and the like; U.S. Pat. No. 2,475,559 (Wilson) Fruit corer and juice extracter; U.S. Pat. No. 1,838,626 (Hurst) Fruit pulping machine; and US 883,763 (Chatain) Fruit-cutter.

### SUMMARY OF THE INVENTION

The present invention relates to a fruit juicer having a portion capable of “juicing”. The invention is particularly suited for being inserted into a fruit or vegetable to produce juice within the fruit/vegetable; however, can also be used as a mixer or blender, i.e. for “juicing” material, typically food, in a blender container or the like.

In accordance with embodiments of one aspect of the present invention there is provided a fruit juicer for juicing, the juicer comprising: a motor for providing a source of rotary motion; and a juicing tree insertable into a fruit or into a mixing container, the juicing tree comprising: a rotatable shaft, operably couple-able to the motor; at least one flexible juicing branch, extending from the shaft; and at least one cutting tool disposed along the shaft or along the at least one flexible juicing branch.

The term “fruit” herein the specification and claims denotes fruit(s) or vegetable(s); or any pulverize-able, mince-able, grind-able material and so forth, typically food; the term “juice” denotes fruit or vegetable juice; or minced, ground or pulverized material, typically food, and so forth; and the term “juicing” includes making fruit or vegetable juice; or mincing, grinding, pulverizing, and so forth.

According to some embodiments, the juicer further comprises a temperature measurement mechanism for measuring the temperature of juice being produced by the juicer; in some embodiments, one or more branches comprises a weight; in some embodiments, one or more branches of the at least one juicing branch extends out from a distal end of the rotatable shaft; in some embodiments, one or more branches of the at least one juicing branch is affixed to the shaft; in some embodiments, the juicing tree comprises three or more branches extending outward from the shaft (this embodiment is significant as prior art juicers that juice within a fruit typically only have one or two branches due to limitations of their branch deployment mechanisms—and the flexibility/bending and resiliency of the instant branches allows several branches to conveniently enter the fruit and expand on their own—whereas prior art juicers of this type typically require an opening mechanism to deploy the branch(es).

In some embodiments, the juicer's motor is a controllable motor; in some embodiments, the controllable motor is adapted to be automatically controlled and has associated therewith a processor/controller to control the rate of rotation of the shaft. In some embodiments, the shaft comprises a filter.

In accordance with embodiments of another aspect of the present invention there is provided a rotatable juicing element or juicing tree for use in combination with a motor providing a source of rotary motion, the juicing tree comprising: a rotatable shaft, operably couple-able to the motor; at least one flexible juicing branch, extending from the shaft; and at least one cutting tool disposed along the shaft or along the at least one flexible juicing branch.

In some embodiments, the juicing tree comprises at least three branches; in some embodiments the branches are at a plurality of levels or layers; in some embodiments the juicing tree comprises a temperature measurement element, in some embodiments one or more branches comprises a weight.

In accordance with embodiments of another aspect of the present invention there is provided a juicing kit comprising: a source of rotary motion; a flexible juicing tree operably connectable to the source of rotary motion; and any one or more items, or combination thereof, from the group consisting of: a straw; a container for receiving a fruit or other juice-able material; a fruit plug; and a corer or pit remover. In some embodiments of the juicing kit, the straw comprises a plurality of straw branches.

According to particular embodiments, the fruit juicer comprises: a controllable motor providing a source of rotary motion, that can rotate clockwise or counter-clockwise according to the user selection, and a rotatable juicing element (“juicing tree”), coupled to the motor. The juicing element is adapted so that it can be retrievably introduced into the interior of the fruit. Juice is produced in the interior of the fruit and the juicing element is retrievable from the fruit to allow inserting a straw into the fruit or for pouring/squeezing juice out from the interior of the fruit.

In some embodiments, the juicing element has a stiff rotatable mixing rod or shaft supporting at least one juicing member or branch, which is flexible and pliable. In some embodiments, the mixing rod includes a flexible portion, typically in an upper portion thereof, to allow the rod to be angled.

The juicing branch(es) are typically elongated and made of flexible plastic (e.g. nylon) line(s)/cord(s), or from rust-proof metal wire(s) or from stainless spring steel or from any other flexible material(s). An example of a suitable nylon line is a nylon copolymer string, having a tensile strength of 8,700 psi, flexural modulus of 150,000 psi and flexural strength of 6,500 psi such as 2 mm diameter nylon, catalogue number NYCOA 2061 from Nylon Corporation of America, at 333 Sundial Avenue, Manchester, US, NH 03103-7230.

While it is a particular feature that the juicer can be used to produce juice within a fruit; the juicer can be used to produce juice within a container—i.e. to be used essentially like a blender; and so to provide multiple implementations. As such, the juicer is provideable as a kit including a container for receiving the flesh of fruits and/or vegetables for juicing.

In regard to kits, in some embodiments, the present invention provides a kit further or alternatively including a corer or pit remover to then allow juicing of fruits/vegetables such as mangoes and avocadoes. Furthermore, in some embodiments the present invention provides a kit further or alternatively including a straw; and in particular embodiments the straw includes a pit or pulp filter; and/or a multi-branching straw-like structure to allow drinking the juice of more than one fruit simultaneously. In addition, in some embodiments, the present invention provides a kit further or alternatively including a stopper or cork to plug/seal any opening that may have been produced upon introduction of the juicing tree into the fruit/vegetable, thereby allowing convenient storage. In some embodiments, the stopper/cork includes a straw interface for receiving the straw and or a portion or base adapted to secure the fruit in a position to help prevent leakage of the juice.

In some embodiments, each juicing branch of the juicing tree can be built/made equally or differently from the other branches; e.g. of different thickness; shape (circular, square, rectangular, triangle etc); length; active length; material(s); weight; elasticity/flexibility; roughness; homogeneity; edge/end (ball shaped, straight cut, etc); angle; location; connection to the rod, etc. Preferably, each juicing branch can also have one or more cutting elements/shapes (cutting tools).

A suitable fruit typically has a relatively thick or sturdy shell, peel, skin or rind (hereinafter in the specification and claims: “rind”) so the rind sturdy strong enough to hold juice inside; is juicy inside and with few seeds. However, as noted or understood from above, the juicer can be used after pitting of the fruit/vegetable or have associated therewith a corer or pitting device therefor.

It is an object of the present invention to provide a juicer that performs juicing on the inside of the fruit, including at least one of the following: low cost; convenient, quick and easy operation; a minimum of parts to clean/maintain (e.g. in this juicer there is only one assembly, the juicing tree, to clean); easy insertion into the interior of the fruit through a naturally occurring protuberance opening (i.e. where the stem of the fruit was attached), or through the peel, whereby a wide variety of fruits can be juiced, for example citrus fruit such as oranges, grapefruits, pomelos, mandarins, clementines, lemons etc, or other fruit like melon, watermelon, pineapple, persimmon etc.

It is another object of the present invention to provide a filter straw that is preferably made from long straight stiff and thin plastic pipe. After juicing, the juicing tree can be removed from the fruit to allow introduction of the filter straw for drinking filtered or non-filtered juice. In some embodiments, the mixing rod of the juicing tree comprises or is adapted to provide the function of a straw. In some embodiments the straw includes a Y-junction (or multi-branching junction) that splits to at least two filter straws.

One particular advantage of the present invention is that the juicing tree is easily inserted into the fruit with no need for moving parts, in contrast to U.S. Pat. No. 1,838,626 (Hurst), which comprises a pulp cutting wire that runs along a mixing rod that needs to be deployed after the mixing rod enters the fruit; as well as many other such juicers designed to produce juice on the inside of a fruit or vegetable.

Another particular advantage is that due to the flexibility of the juicing tree, not only is it easily inserted into the fruit, the juicing tree may comprise several branches whereby juicing tends to be more efficient and yield more juice.

Yet another particular advantage of some embodiments is that due to the design of the juicing tree, the juicing tree can conveniently include one or more juicing or cutting elements—typically located along the branches of the juicing tree. These cutting elements also tend to improve the juicing, in particular providing more juice in a shorter time. Shorter juicing time tends to retain the vitality of the juice by limiting the temperature of the juice.

In regard to the vitality of the juice, a further advantage of some embodiments includes the incorporation of a temperature measurement element, e.g. a thermocouple, in the juicing tree to provide information to control the operation (manually or automatically) of the juicer. This control can be manual, e.g. by the user reducing the rotational speed of the juicing tree or temporarily turning off the juicer; or automatically, via a control system of the juicer. For such purpose, in some embodiments, the present juicer can be implemented in the form of a kit, further including one or more graphs and/or tables indicating juice vitality (e.g. enzyme activity, vitamin concentration) as a function of temperature. In some embodiments, such graphs/tables can include graphs/tables for individual fruits and/or data for a typical fruit to be juiced, such as an orange Likewise, in particular embodiments, the juicer includes a controller or processor including automatic control, or programmable to control the juicing process (in particular the rotation speed of the juicing tree). The controller may include a user interface to allow the user to input the fruit being used whereby the processor/controller will utilize an algorithm to control the temperature of the fruit to provide a balance between juicing time and vitality of enzymes and vitamins.

Another advantage is that fruit juicer is easily cleaned and maintained. Only the juicing tree of the juicer requires cleaning, and the juicing tree is easily cleaned and maintained as it does not contain intricate parts, internal portions or moving parts—as is an issue with much of the known juicers of this type.

### BRIEF DESCRIPTION OF THE DRAWINGS

The present invention will be understood and appreciated more fully from the following detailed description taken in conjunction with the appended drawings in which:

FIG. 1 is a side view of an embodiment of a fruit juicer according to the present invention.

FIG. 2 is a side view of another embodiment of the fruit juicer.

FIG. 3 is a top cross-section view of mixing rods/shafts and juicing branches, illustrating exemplary connection orientations.

FIG. 4 is a cross-section view of the mixing rods/shafts and juicing branches illustrating exemplary shapes and connections options.

FIG. 5 is a side view of the fruit juicer showing details of a juicing tree penetration limiter sub-unit.

FIG. 6 is a side view of another embodiment of the juicing tree.

FIGS. 7 and 8 are side views of exemplary straws for complementary use with the fruit juicer.

FIGS. 9 and 10 are respective side and perspective views of exemplary fruit-opening plug for complementary use with the fruit juicer.

FIG. 11 is a perspective view of another embodiment of the juicing tree of the present invention.

FIG. 12 is a side view of another embodiment of the juicing tree according to the present invention, comprising cutting tools.

FIGS. 13-15 show further exemplary cutting tools.

FIGS. 16-18 are side views illustrating insertion of the juicing tree into a fruit; the fruit in section.

FIG. 19 is a side view illustrating the juicing tree inserted within a fruit; the fruit in section.

FIG. 20 is a perspective view of another embodiment of the fruit juicer.

FIG. 21 is an enlarged perspective view of area “A” of FIG. 20.

FIG. 22 is an enlarged perspective view of a cutting tool of FIG. 21.

FIG. 23 is a perspective view of another exemplary cutting tool.

FIGS. 24 and 25 are graphs depicting exemplary operation of the juicer.

FIG. 26 is a side view of a juicing tree shaft illustrating numerous exemplary cutting tools affixed thereto.

FIGS. 27 and 28 are side views of juicing trees illustrating numerous examples of cutting tools affixed to or part thereof.

FIG. 29 is a side view of a straw extension for complementary use with the juicer.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

Illustrative embodiments of the invention are described below. In the interest of clarity, not all features/components of an actual implementation are necessarily described.

The present invention is particularly suited for making fruit juice in an interior of a vegetable or fruit having a relatively soft marrow or flesh and strong or tough rind/peel, typically a citrus fruit—and will be described using this implementation; however, the juicer is versatile and can also be used to “juice” certain other types of fruits or vegetables and furthermore other substances, though typically food, which can be disposed in a container (i.e. not within a fruit).

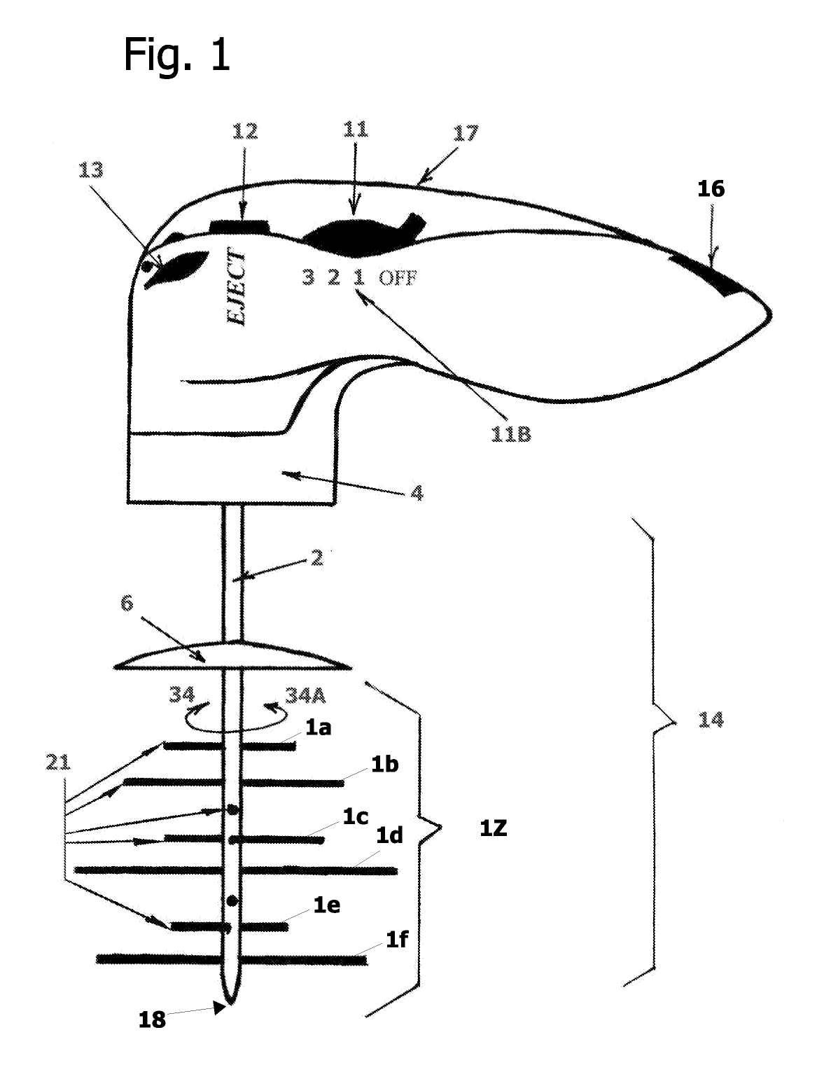

FIG. 1 shows an embodiment of the juicer including a rotary juicing device or juicing tree 14; a control and drive unit 20A; and a mechanical interface unit 4. Juicing tree 14 includes a mixing rod or shaft 2, with a distal end or tip 18; a shaft penetration limiter 6 and juicing branches such as branches 1a-1f, collectively designated as juicing branches 1z, having distal ends 21. Juicing branches 1z can be fixed in different locations, in vertical and/or horizontal angles and different elevations. Juicing branches 1z are designed to juice the inner contents of the fruit when the mixing rod 2 rotates therein.

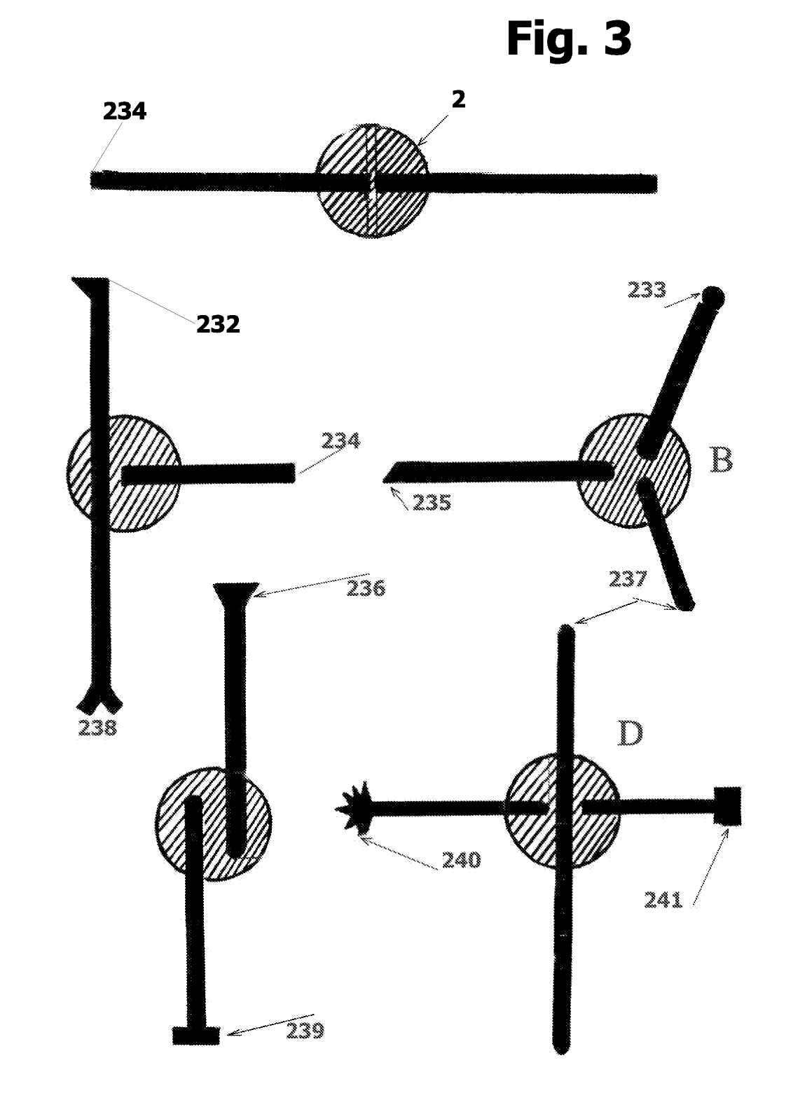

Juicing tree 14 is coupled to a motor 7 (FIG. 3) by a mechanical interface unit 4 (for example a quick-release type mechanism) and configured for retrievable introduction into the interior of the fruit. Juicing tree 14 is rotated by operation of motor 7 to produce juice that remains in the interior of the fruit. Motor 7 is adapted to allow clockwise or counter-clockwise rotary motion (as depicted by directions 34 and 34a of the double-headed in FIG. 1).

Control and drive unit 17 typically includes features such as an a control selector such as on/off button or lever 11, which may include speed indices 11B; an eject button 12 for releasing juicing tree 14; operation indicators such as LED 13; and a socket 16 for an electric cable (not shown). Optionally, the juicer has an advanced control unit that has the capabilities to communicate with a host computer for processing, acceleration, deceleration, upgrading work-plans for the motor in IC's or for off line programming.

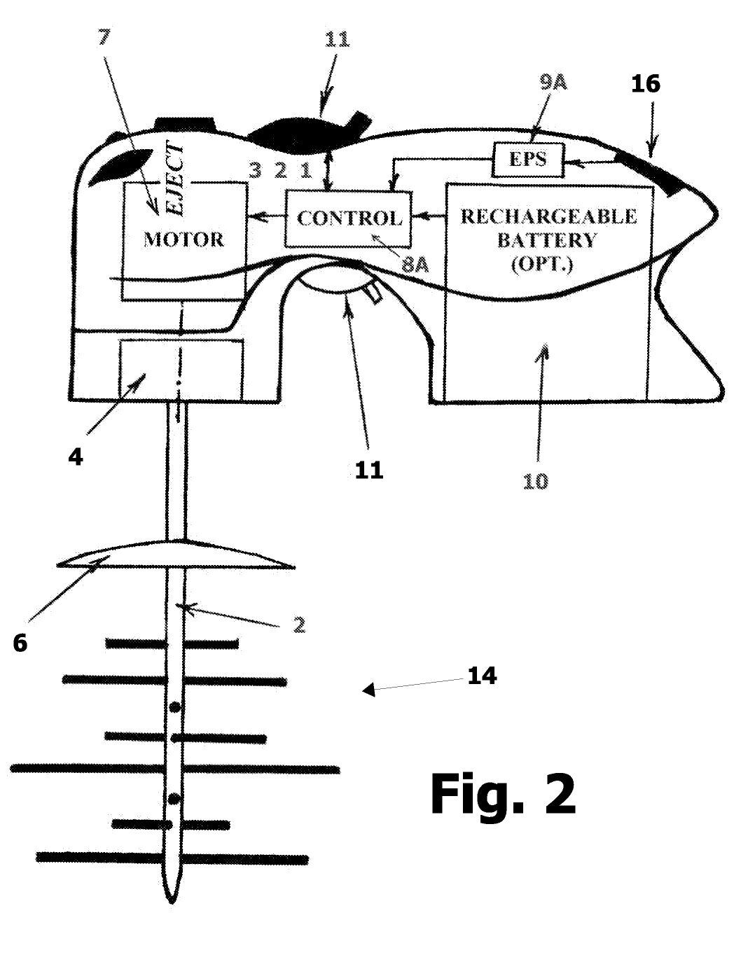

FIG. 2 shows additional components in accordance with some embodiments of the juicer including a controller 8A; power supply or transformer 9A; and a rechargeable battery 10.

FIG. 3 illustrates exemplary juicing branch ends, i.e.: triangular 232; ball 233; flat 234; angled or beveled 235; frusto-conical 236; rounded 237; forked 238; rectangular 239; thorny 240; and square 241. Also exemplified are branch orientations with respect to each other, such as co-linear; T-oriented; 3-pronged; parallel; and perpendicular.

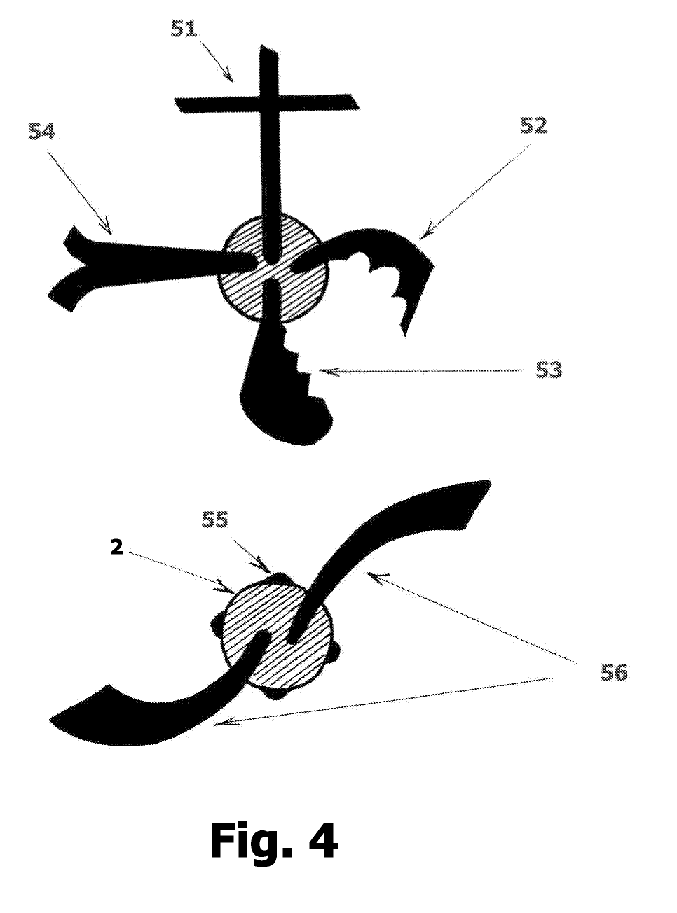

FIG. 4 illustrates that each juicing branch can have its own design and a variety of designs e.g. varied thickness, width, shape (such as: antenna 51; hooked 52; saw toothed 53; tapering 54; crescent 56)—and mixing shaft 2 can include a rough surface, for example having bumps or protrusions 55.

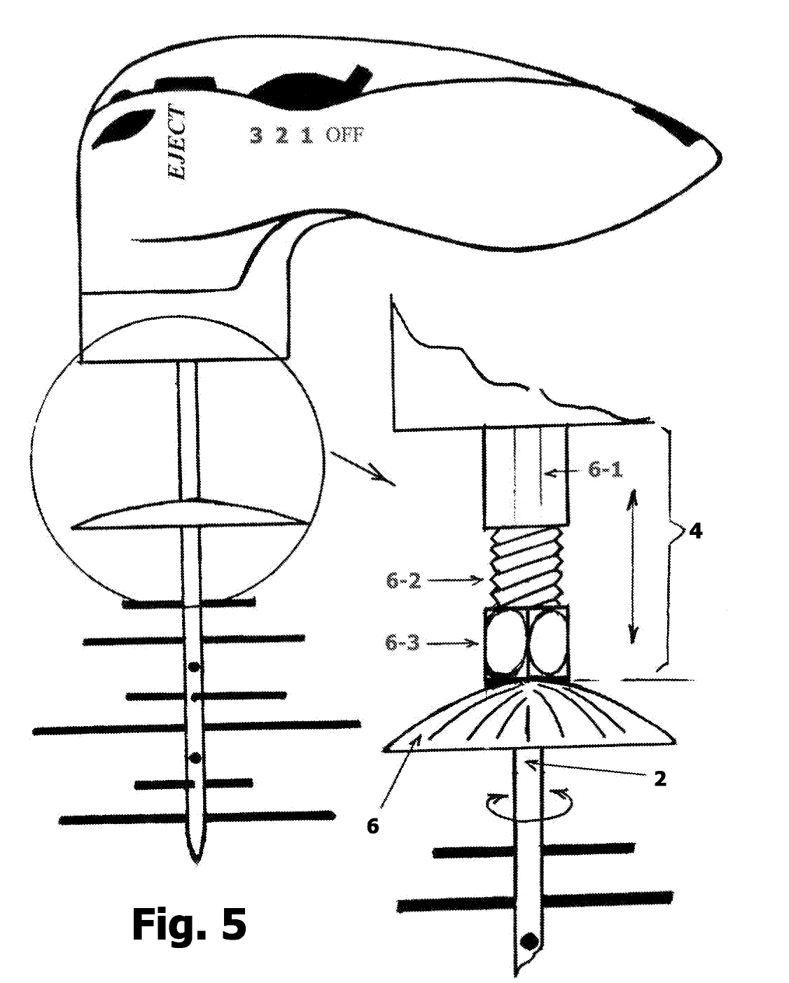

With reference to FIG. 5, shaft penetration limiter 6 can be positioned to suit the fruit size, e.g. via a screw-thread 6-2, or any other positioning and fixing means, which is settable manually by the user to the desired position, to avoid damage to the fruit's peel and prevent leakage. Thread 6-2 corresponds to a limiter positioning nut 6-3; and the thread can also be used to connect the shaft 2 with a corresponding interface nut 6-1, which are components of mechanical interface unit 4.

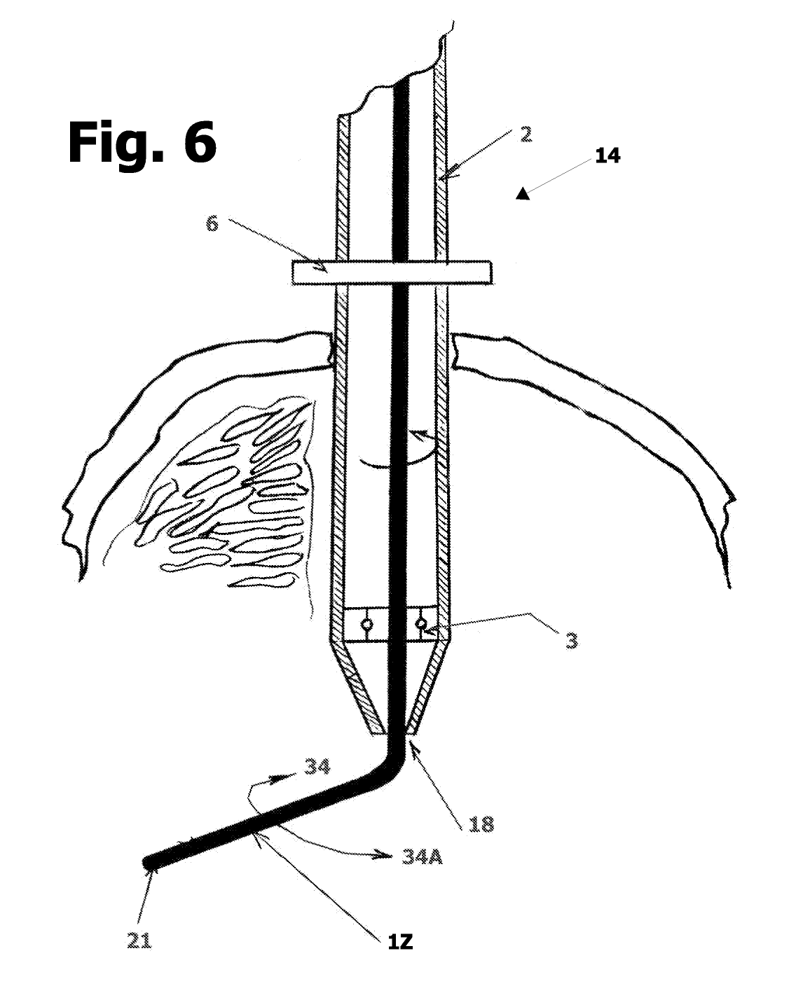

FIG. 6 shows an embodiment of juicing tree 14, inserted into a fruit, wherein mixing shaft 2 is hollow and juicing branch 1z passes there-through, exiting at an opening at tip 18. In this embodiment, when motor 7 rotates shaft 2, branch 1z is moved or swung to produce a whip or flail-like branch. The hollow shaft 2 thus essentially comprises an inner filter straw, which can be built/drilled/shaped or cast inside. In some embodiments, hollow shaft 2 may also comprise a ball bearing member 3 to help align branch 1z.

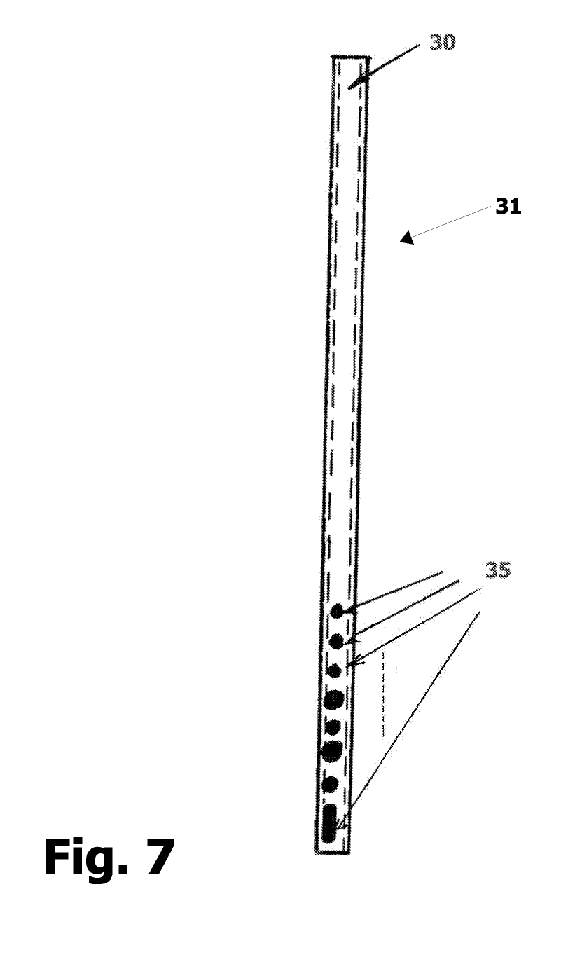

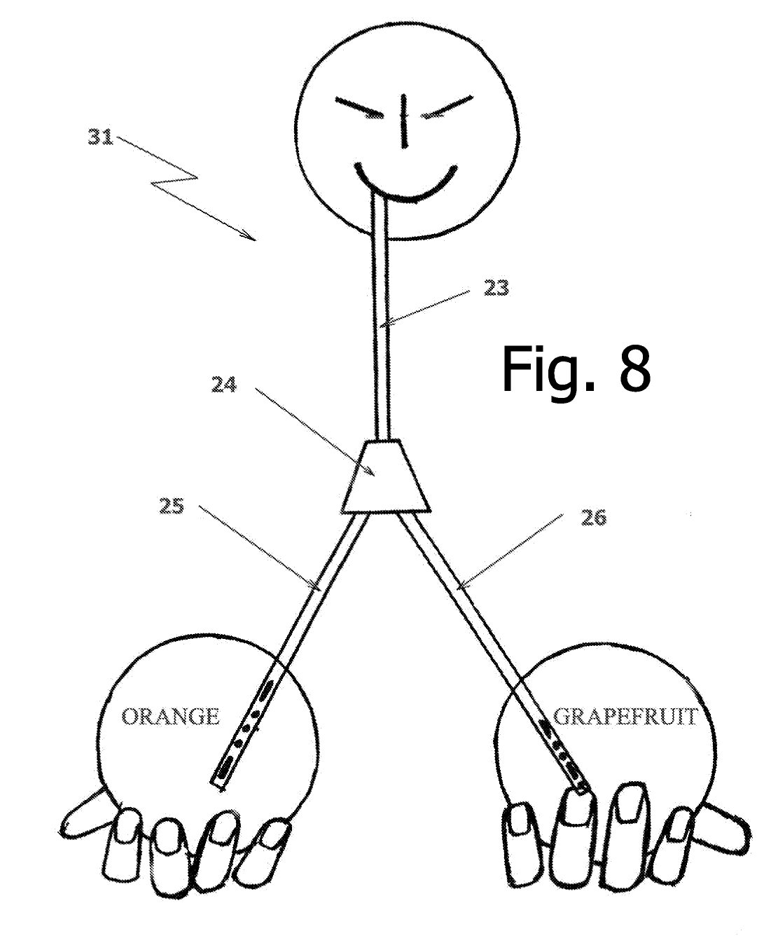

FIGS. 7 and 8 show exemplary straws, in particular filtering straws, for complementary usage with the fruit juicer.

In FIG. 7 a single straw 31 is shown having a passage 30 and at least one juice entrance opening, such as openings 35, which can be of various shapes and sizes in relation to the juice (fruit), in particular what one wishes to filter (e.g. pulp, small seeds, large seeds, etc). In embodiments such as mentioned above wherein shaft 2 is hollow, the shaft may also have filtering openings (such as filtering openings 35).

In FIG. 8, a branched filtering straw is shown, having a suction segment 23, and two fruit engaging segments 25 and 26, whereby a drinker can drink two fruits at the same time, which is particularly advantageous for mixing the juice of juiced fruits, for example a grapefruit and an orange. The segments 23, 25 and 26 can be formed as one unit, or, as illustrated in FIG. 8, the segments can be joined by a union 24 designed to receive and reversibly hold the segments.

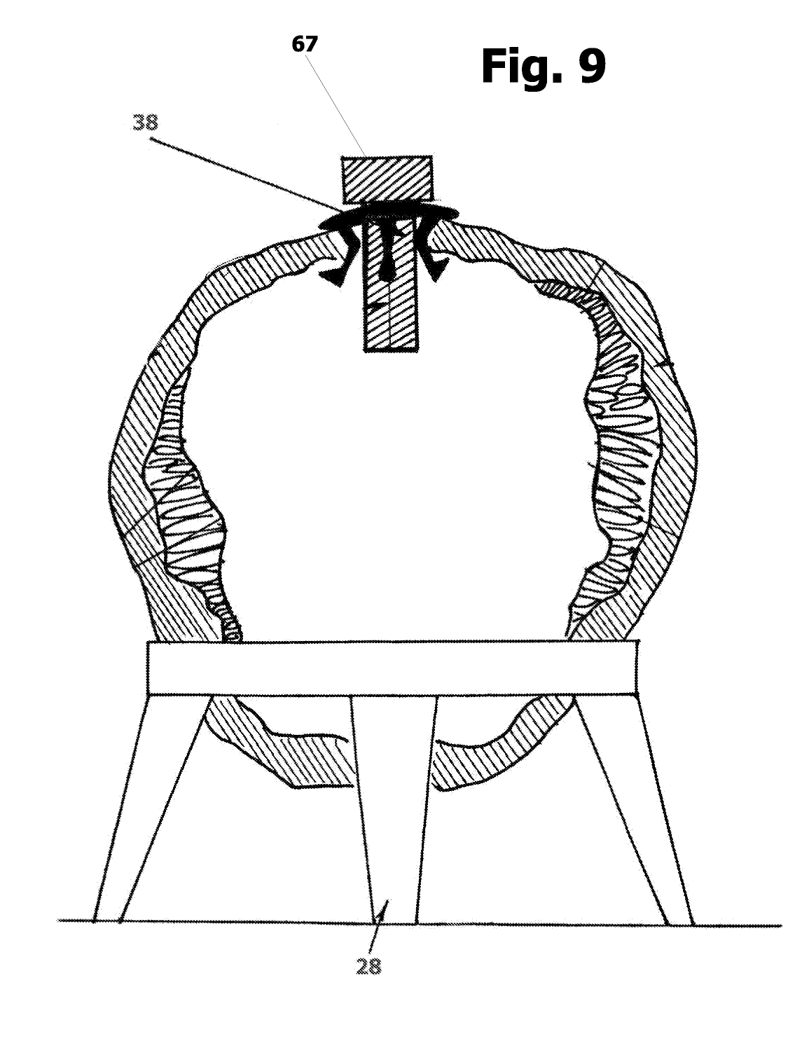

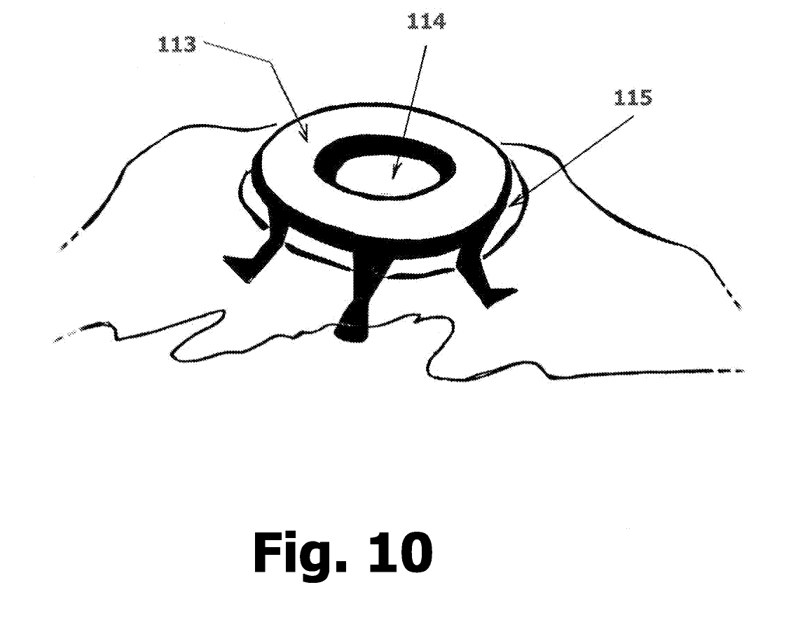

FIGS. 9 and 10 show an exemplary fruit-opening seal or plug 38 for complementary usage with the fruit juicer. In some embodiments, plug 38 has an opening or flap 114 (that can expose the opening) through which a straw, e.g. straw 31, can be placed. Flap 114 can be connected to an annular plug member 113, preferably a resilient member; or alternately, the annular plug member can define an opening for a straw. Thus, plug 38 can also be considered to be, or to comprise, a straw interface mechanism, which, as seen in FIG. 9, may include a cork-like member 67. Plug 38 can be used to seal any opening that may have been produced prior to or upon introduction of juicing tree 14 into the fruit, thereby allowing convenient storage. Also illustrated in FIG. 9 is an exemplary fruit holding base 28.

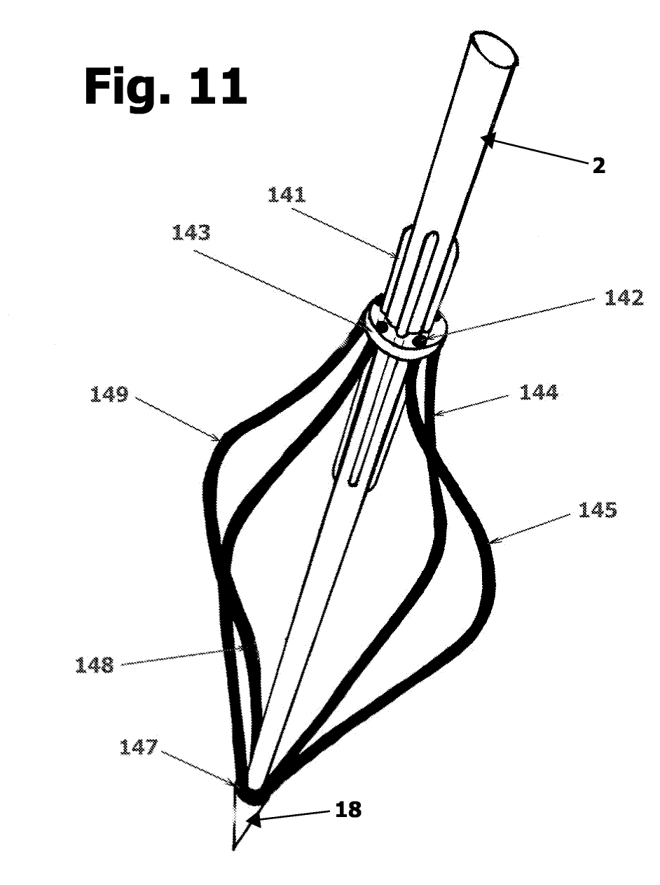

FIG. 11 shows another embodiment of the juicing tree wherein the branches are in the form of flexible strings or cables, for example cable lines 144, 145, 148 and 149. At their distal ends, the lines are attached to shaft 2 (exemplified by a tapering shaft) by an eyelet-type ring 147 adjacent tip 18 (exemplified as a pointy tip). At their proximal ends, the lines are attached to a slidable ring 143, for example at openings 142 of the ring. Slidable ring 143 slides along ribs 141 of shaft 2; and is thus correspondingly designed. Slidable ring 143 helps juicing tree 14 to be adjustable to fruits of different sizes. In operation, upon rotation of shaft 2, lines 144, 145, 148 and 149 swing outward to juice the pulp of the fruit.

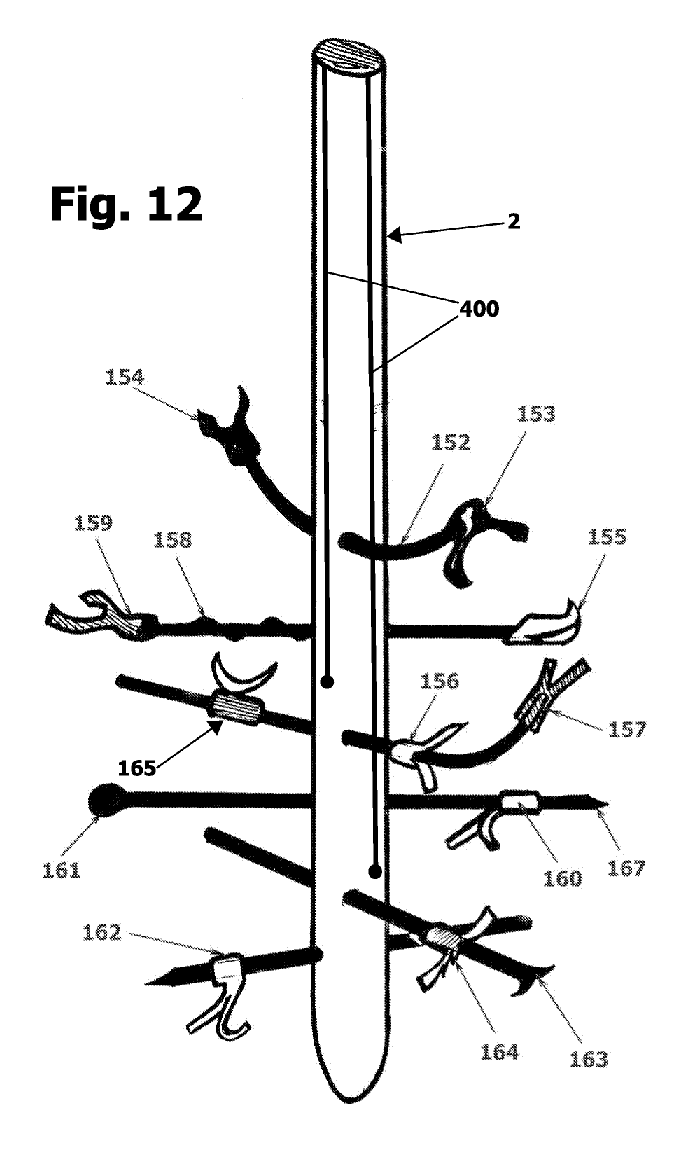

FIG. 12 illustrates an embodiment of juicing tree 14 according to the present invention wherein the branches, along and/or at the distal end thereof, include various cutting tools 152-165. It is a particular feature of the juicing tree, and juicer comprising it, that there are included such cutting tools, which are particularly helpful in improving the extent and efficiency of the juicing process. In some embodiments, the cutting tools are integrally formed with the branches; whereas in other embodiments the tools are attached to the branches by a variety of suitable means, for example: sliding thereon; crimping; welding; gluing; and in some embodiments, the cutting tools can be formed in halves or portions that are glued together to surround a branch or line in order to affix them. In some embodiments, the cutting tools are made from an edible or ingestible material whereby if the tools or portions thereof break off and mix with the juice, they can be consumed along with the juice without causing harm.

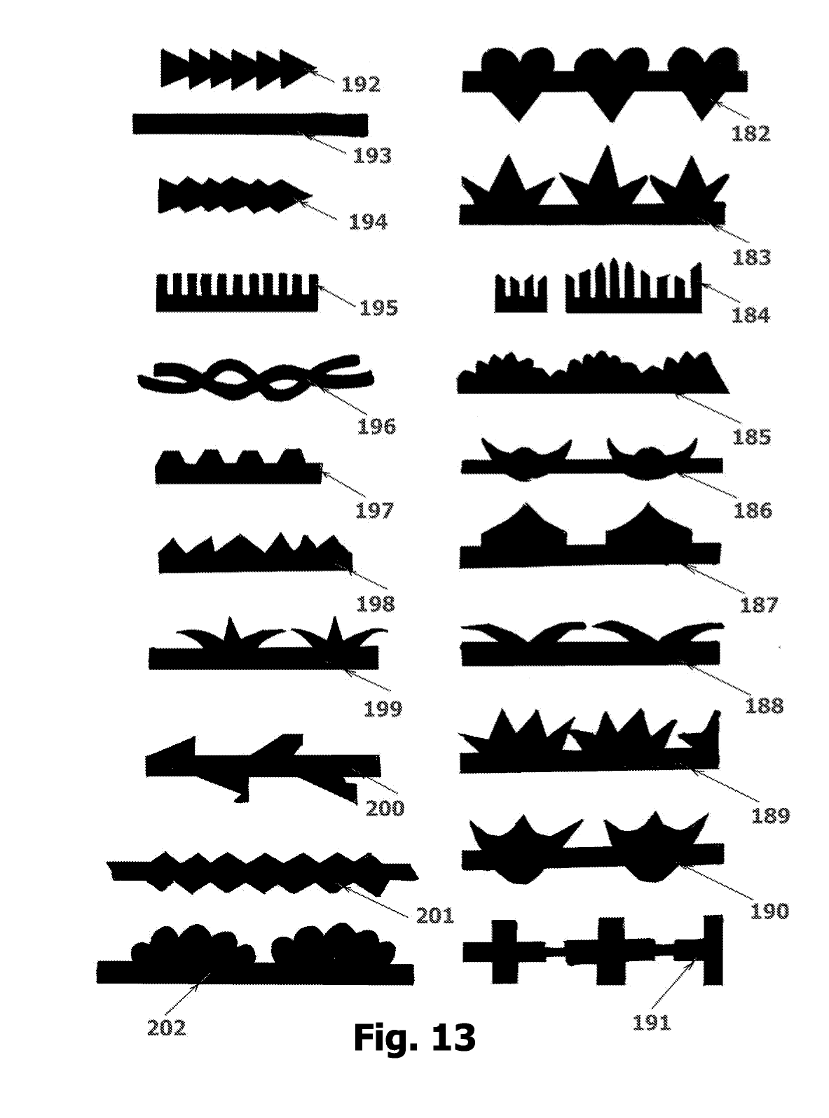

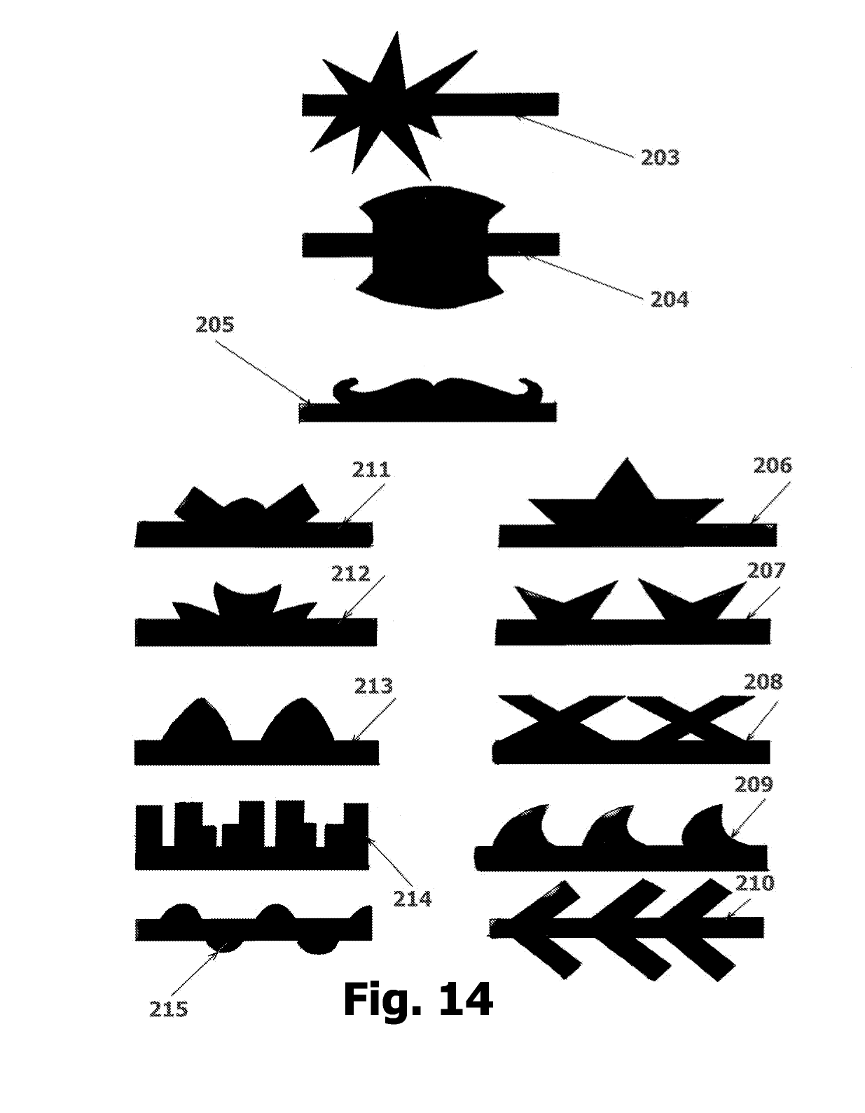

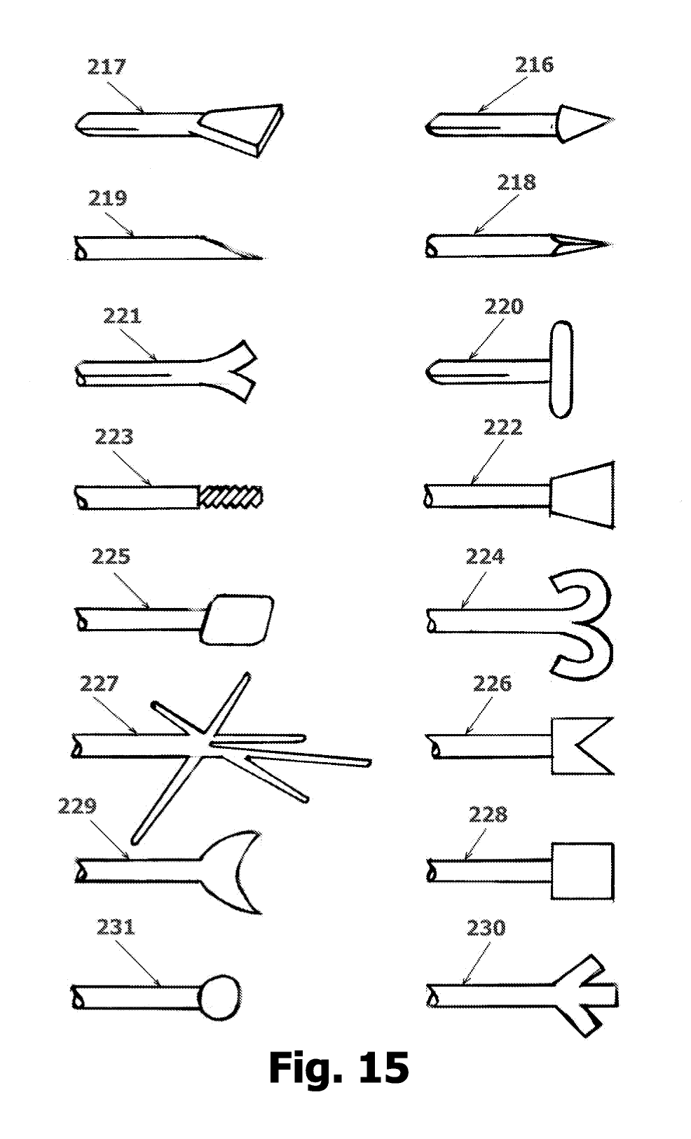

FIGS. 13-15 show further exemplary cutting tools; FIG. 13 illustrating tools 182-202; FIG. 14 illustrating tools 203-215; and FIG. 15 illustrating tools 216-231. These exemplary tools provide designs that may be of particular efficiency when juicing fruits in general and specific fruits, in particular.

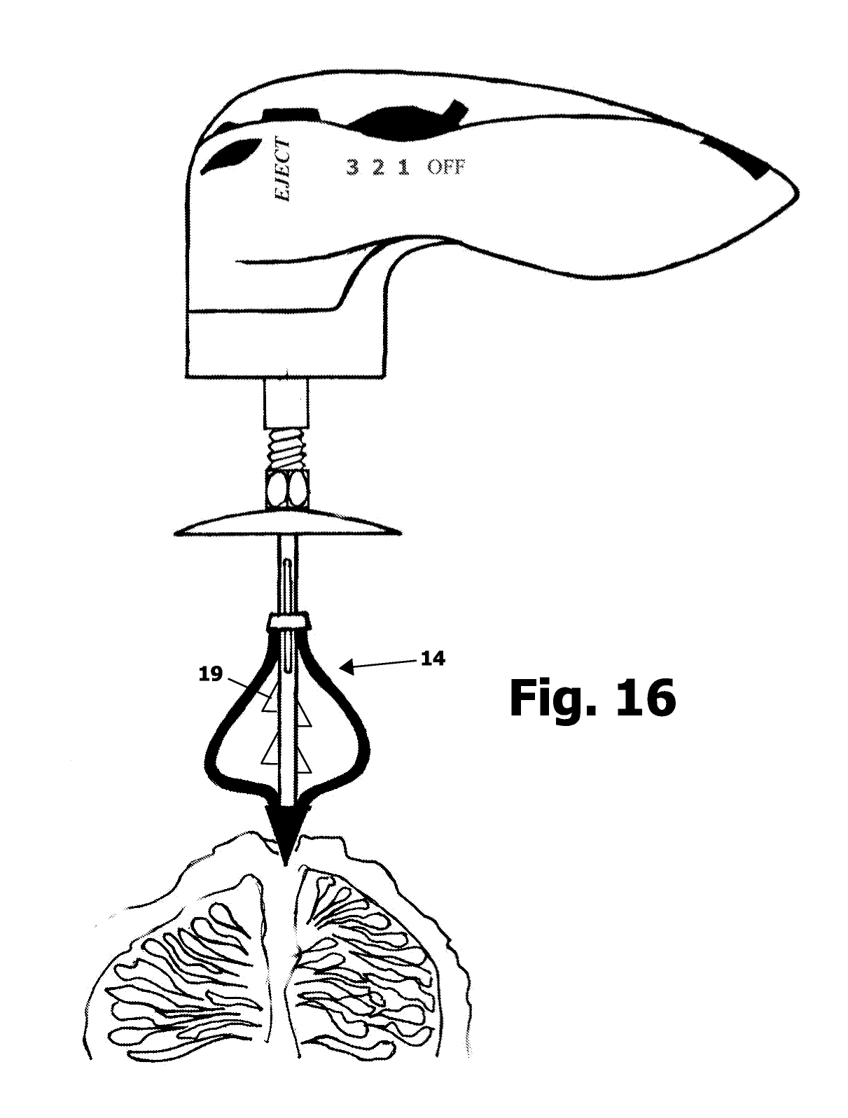

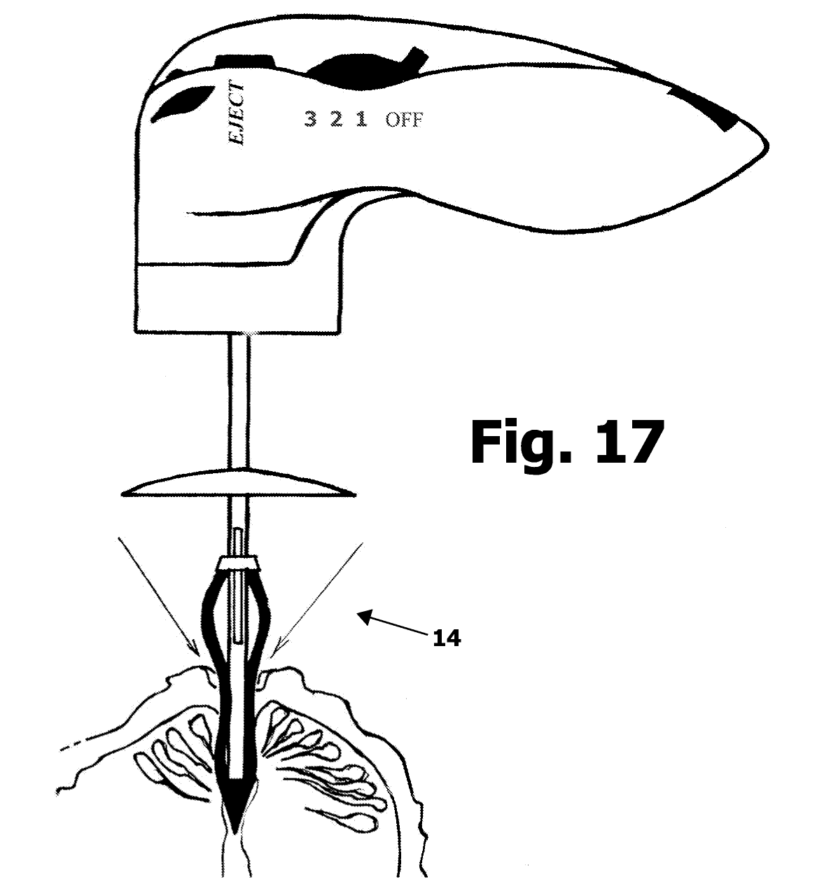

FIGS. 16-18 show the embodiment of juicing tree 14 as noted in FIG. 11, respectively beginning insertion into an orange; partially inserted in to the orange and fully inserted into the orange. FIG. 16 also illustrates, that in some embodiments, shaft 2 can also comprise one or more cutting tools, for example triangular cuttings tools 19.

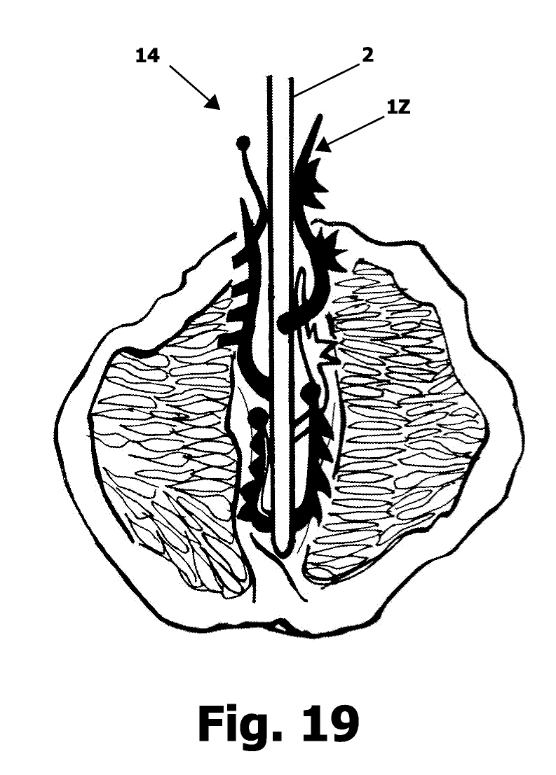

FIG. 19 shows juicing tree 14 inserted within the orange; however, in this embodiment, the juicing tree includes a variety of cutting tools. It is important to note, as seen in this figure, that the flexibility of branches 1z allow the juicing tree 14 to enter the fruit via a small opening, even where the branches have cutting tools.

Juicing branches 1z (or lines) can be designed as twined fibers or wires or from one homogeneous fiber or wire; and the branches/lines, as seen on figures referred to above, can also have various end pieces and shapes and pieces along the branches, e.g. triangle, rectangular, thorny, square, circular, blade, straight cut, split head, ball-shaped and so on. Branches 1z can also be inserted or anchored/attached at various locations along mixing shaft 2, and various angles thereto. Branches 1z can be attached to shaft 2 by drilling a recess or hole in the shaft, by casting the mixing rod/shaft and juicing branches together at one piece, adhesive, pressure fit, etc. It is a particular feature of the design of juicing tree 14 that due to the flexible nature of branches 1z, the juicing tree can comprise a plurality of branches, typically several, and still be conveniently and easily inserted into the fruit through a relatively small opening, such as the natural opening adjacent where the fruit was attached to its stem.

During the insertion, juicing branches 1z fold backward until they enter into the interior of the fruit. Inside the fruit, juicing branches 1z can bend and/or twist during the controlled rotation of mixing shaft 2, which according to some embodiments can include a vertical (up-down) motion, which may improve juicing efficiency. Juicing branches can be inserted via peel locations other than the aforementioned naturally occurring opening; however, preferably via a small opening.

As mentioned, juicing tree 14 can include several branches 1z; and it should be noted that there can be several layers of juicing branches, as seen in FIG. 1, inter alia. The quantity and spacing or branches 1z depends on the size and the structure of the fruit; i.e. according to some embodiments, the juicer can come with a plurality of juicing trees, including those with many branches and with short or long branches to ensure proper use with broad size range of fruits. Regardless, vertical (up-down) motion by the juicer can be used advantageously to increase juicing efficiency; and the flexibility of the branches not only allows convenient insertion into the fruit, they can bend to allow use with a range of fruit sizes.

Any part of any branch 1z or cutting tool (e.g. blades, edges/ends, net can be made from any homogeneous material(s) or different materials (e.g. silicon, rubber, plastic, nylon, metal etc), that have different or equal elasticity, density, strength, shapes and color.

After juicing and removal of juicing tree 14, straw 31 can be used to drink the juice directly from the fruit, like from a drinking cup. In some embodiments, shaft 2 comprises filtering means, or example one or more openings 3.

Juicing branches, work as a high speed-rotating whip, particularly in embodiments where there is a branch extending from tip 18 of shaft 2. In some embodiments, the distal end 21 of the branches has a small ball to help prevent damage to the inner fruit peel while it is rotating inside the fruit.

Reverting to FIG. 12, it is a particular feature of the present invention that there is provided one or more temperature measurement sensors, e.g. thermocouple(s) 400 or any other suitable temperature measurement element, disposed in shaft 2 and/or in one or more branches 1z. Control of the rotation onset/offset or the speed thereof is preferably mediated in accordance with the temperature readings obtained by such thermal sensors, for example thermocouples 400. Alternatively, a temperature measurement element can be inserted into the interior of the fruit at another location. This temperature measurement element is part of a temperature measurement mechanism that also includes a controller, e.g. controller 8A, for controlling the operation of the juicer, in particular the rotation of juicing tree 14 to help avoid high temperatures which may harm the vitality of the fruit.

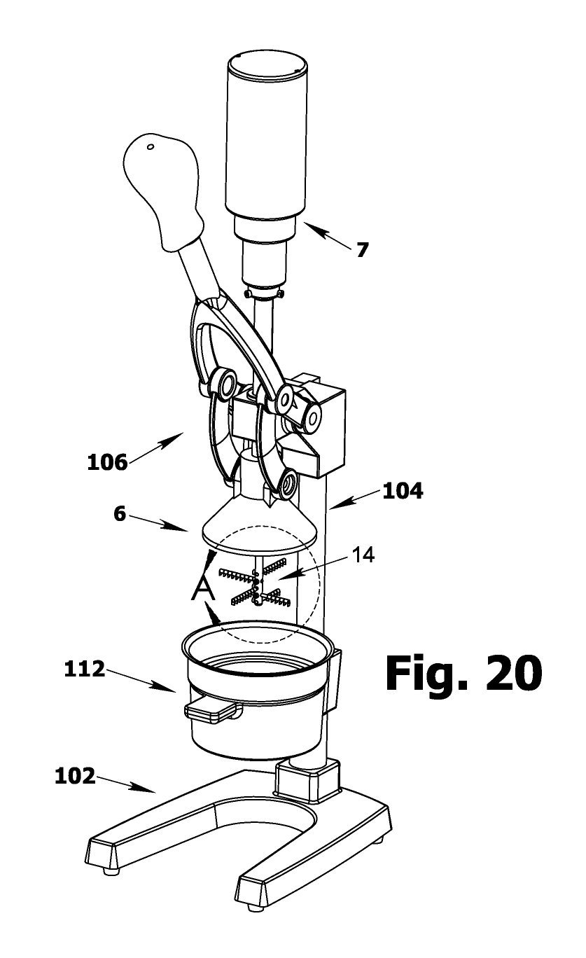

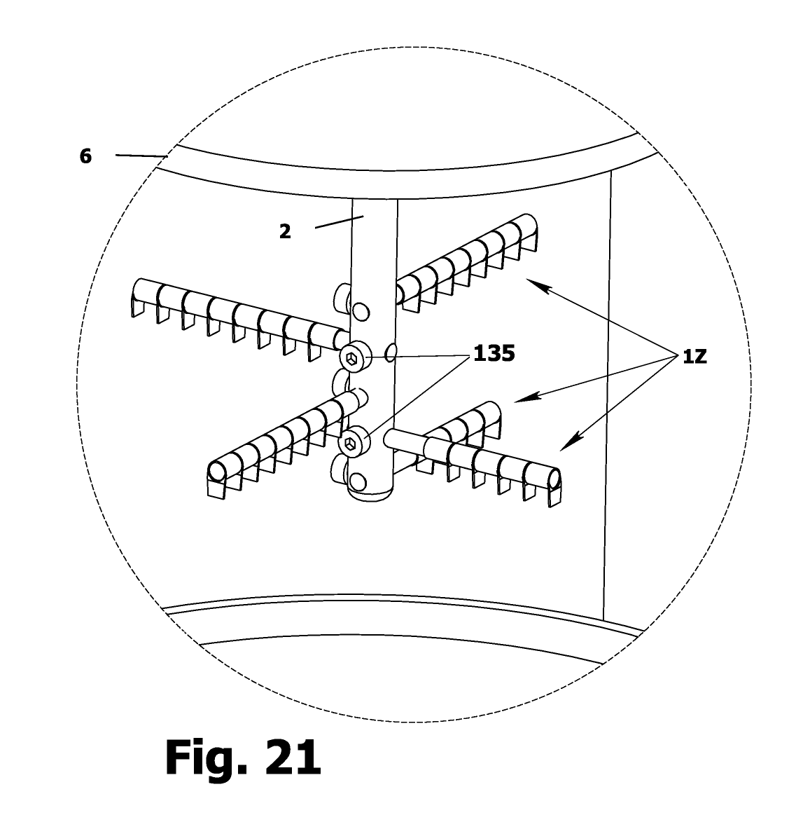

FIGS. 20 and 21 show a preferred embodiment of the juicer comprising a pedestal 102; a post 104 having a fruit mount or holder 112 attached thereto; a descending mechanism 106 and motor 7. Descending mechanism 106 may employ various configurations known in the art, in order to allow the descent of juicing tree 14. Fruit holder 112 may include a drain aperture (not visible), for some of the operating modes of the juicer; and may include a plurality of inserts (not shown) to accommodate different types of fruits and/or fruits of different sizes.

The electrical circuitry powering motor 7 preferably includes a rotational speed regulator, which is capable of attenuating the motor's speed, from the maximally applicable values a slower speed or to zero RPM. The electrical circuitry preferably includes a controller pre-programmed with the aforementioned operating modes, comprising predefined schemes of the parameters, e.g. counter/clockwise direction, rotational speed, duration, etc., so upon selection of a given operation mode the controller implements the corresponding scheme.

FIG. 21 shows an enlarged view of juicing tree 14, which in this embodiment has five flexible juicing branches 1z at five layers or levels. Juicing branches 1z are affixed to shaft 2 by set-screw like fasteners 135. As noted above, branches 1z are characterized by a flexibility allowing the branches to fold back toward shaft 2 upon insertion into the fruit; and for such purpose, the cutting tools of each branch are spaced apart from the shaft. The diameter of the branches 1z in this embodiment typically ranges from about 0.5 to about 3 mm.

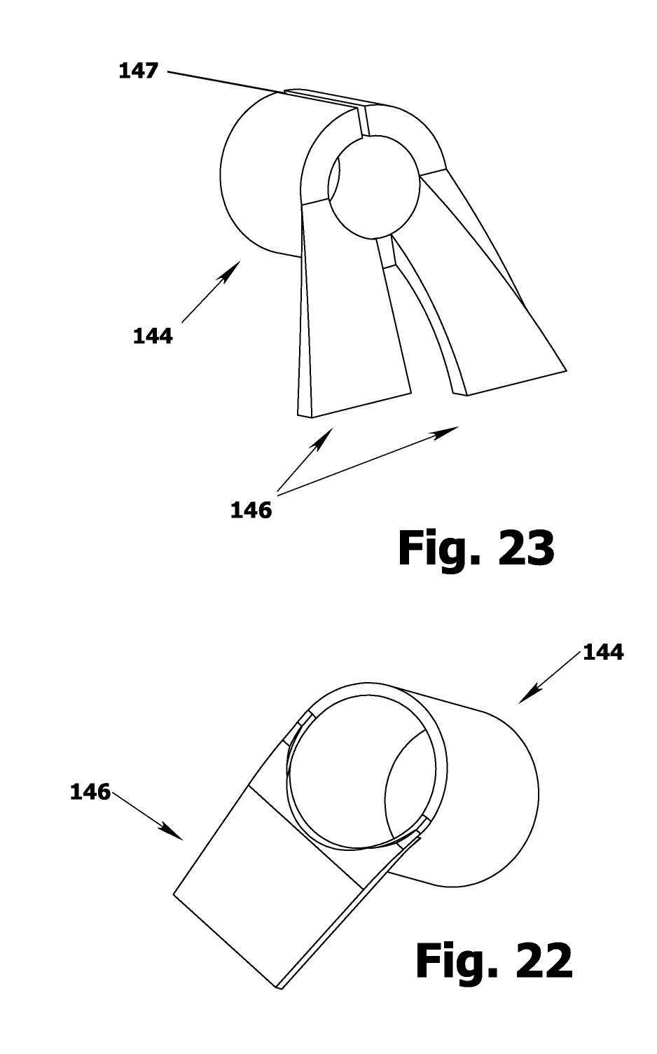

In this embodiment, branches 1z each have a plurality of cutting tools formed in the shape of a cylinder 144 (see also FIG. 22) adapted for fitting over the branches and having a tab 146 protruding perpendicular to the axis of the tools (i.e. longitudinal axis of the branches). FIG. 23 illustrates another exemplary cutting tool, which is similar to that shown in FIG. 22, however having a plurality of non-parallel tabs 146.

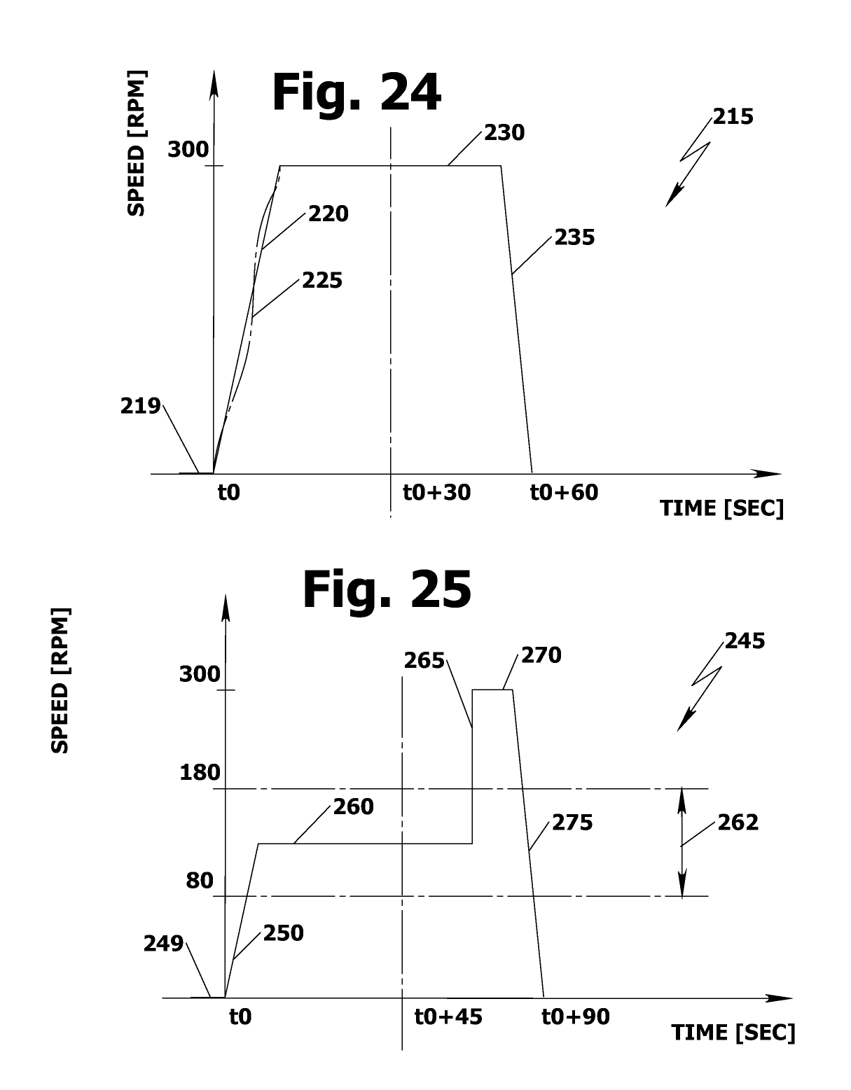

FIG. 24 relates to operation regarding the particular processing steps of the first modus operandi, and shows a plot 215 of the rotational speed (X-axis, RPM) of the juicing tree's shaft 2 as the function of time (Y-axis, seconds). Preparation of the fruit and appending thereof may be performed at step 219. The processing commences at step 220 by accelerating the rotational speed of the juicing tree's shaft 2 from 0, at t0, to about 300 RPM. Since the structural integrity of the fruit's interior, which deteriorates during the processing, inhibits the rotation of the juicing tree 14, the elevation of the rotational speed may take several seconds to accomplish and the gradient of acceleration may assume a non linear or sloop-like profile, as exemplified by dashed line 225.

In favor of those who shall engage in an experimentation guided by this disclosure, it is noted that approximately 300 RPM was found to be essentially the maximal appropriate speed, whereas a rotation exceeding 300 RPM was found to have a negative effect on the components of the juicing device and the quality of the end product. Therefore the processing is preferably to be performed at approximately maximally applicable values, of about 300 RPM.

The processing continues at step 230, by remaining the rotational speed of the juicing tree's shaft 2 at about maximally applicable values of 300 RPM. During step 230 the interior of the processed fruit, e.g. the pulp, get ground and the liquid fraction of the juice is released from the cellular structures wherein it confined in a non-processed fruit. During step 230 the pulp and other non-liquid fractions of the processed fruit are urged toward the fruit's peel due to the centrifugal force resulting from the rotational movement within fruit's interior. At the time of about t0+30, indicated by the vertical dashed line, about 75 percent from the total yield of the juicing process is achieved; whereas during the following 30 seconds solely about 25 percent from the total yield of the juicing process is accomplished. These results came-up during tests of average juicy yellow and/or red grapefruits.

The processing is terminated at step 235, by abruptly decelerating the rotational speed of the juicing tree's shaft 2 to zero RPM. During step 235 the pulp is mainly remained across the interior surface of the fruit's peel and a substantially clear juice can be drawn or poured from the processed fruit.

During steps 230 and 235 the pulp and other non-liquid fractions of the processed fruit are urged toward the fruit's peel due to the centrifugal force resulting from the rotational movement within fruit's interior and a substantially clear juice can be drawn or poured from the processed fruit. Provided that the drain aperture was formed at the bottom of the fruit prior to the processing thereof, the substantially clear juice drains during steps 230 and 235 into a receptacle that may be placed underneath the fruit mount. Provided that the drain aperture was not formed at the bottom of the fruit prior to the processing thereof, the substantially clear juice resulting from steps 230 and 235 can be drawn or poured from the processed fruit, by using straw or slanting the fruit, respectively.

A second modus can be implemented to produce a relatively clear juice, without a substantial portion of the pulp therein and while preserving the biologically pivotal ingredients in the juice, particularly the heat-sensitive ones. Fresh juices a praised and appreciated due to the healthy contents of biologically pivotal ingredients thereof, inter alia including enzymes, co-enzymes and vitamins. Some of these biologically pivotal ingredients are heat-sensitive and can be destroyed during a 60 second period of processing at approximately maximally applicable values, of about 300 RPM, inter alia due to the heat resulting the processing and accumulating inside the fruit and the mechanical impact the interior thereof sustains. Therefore, the second modus provides for a milder processing with a relatively brief escalation to approximately maximally applicable values, to induce centrifugal action on the pulp and urging thereof towards the inner surface of the fruit's peel, at the terminal steps of the modus. The second modus is typically characterized by formation of a drain aperture, typically at the bottom of the fruit.

FIG. 25 relates to operation regarding the particular processing steps of the 2^{nd} modus operandi, and shows a plot 245 of the rotational speed (X-axis, RPM) of juicing tree's shaft 2 as the function of time (Y-axis, seconds). Preparation of the fruit and appending thereof may be performed at step 249. The processing commences at step 250 by accelerating the rotational speed of shaft 2 from 0, at t0, to about 130 RPM. Since the structural integrity of the fruit's interior, which deteriorates during the processing, inhibits the rotation of the juicing tree 14, the elevation of the rotational speed may take several seconds to accomplish and the gradient of acceleration may assume a non linear or sloop-like profile.

The processing continues at step 260, by remaining the rotational speed of shaft 2 between the values ranging from about 80 to about 180 RPM, as indicated by arrow 262. During step 260 the interior of the processed fruit, e.g. the pulp, get ground and the liquid fraction of the juice is released from the cellular structures wherein it confined in a non-processed fruit. At the time of about t0+45, indicated by the vertical dashed line, about 75 percent from the total yield of the juicing process is achieved; whereas during the following 30 seconds solely about 25 percent from the total yield of the juicing process is accomplished.

The processing further continues at step 265 by abruptly by accelerating the rotational speed of shaft 2 from above-defined values range of step 260, at time about t0+75, to approximately maximally applicable values, of about 300 RPM. During step 270, from about t0+75 to about t0+90, the rotational speed of juicing tree shaft 2 is remained at approximately maximally applicable values, of about 300 RPM.

The processing is terminated at step 275, by abruptly decelerating the rotational speed of shaft 2 to zero RPM.

During steps 260, 265 and particularly during the spin of step 270, the pulp and other non-liquid fractions of the processed fruit are urged toward the fruit's peel due to the centrifugal force resulting the rotational movement within fruit's interior and a substantially clear juice can be drawn or poured from the processed fruit; whereas the heat produced and accumulated during a relatively milder processing of steps 260 and 265 is not intense enough, thus the biologically pivotal ingredients in the juice are preserved.

As such, according to one embodiment, motor 7 is a 12V DC motor having a rotational speed of up to 350 RPM, and capable of producing a rotational torque in the range from zero to 24 Newton per meter (N/m). The motor is typically operationally connected to a planetary gear transmission. The output of the planetary gear transmission preferably comprises a fastener for dismounting juicing tree.

The process: a user inserts the juicing tree 14 with all its flexible juicing branches 1z and their components (end devices, edge units, cutting tools/elements, etc.), slowly into the interior of the fruit, preferably vertically, preferably through the protuberance hole and preferably without any rotation. Then the user operates motor 7 to rotate juicing tree 14.

Optionally, the user may move the descending mechanism 106 juicer in order to locate juicing tree 14 at various positions inside the fruit, during rotation. If the user is using a juicing tree 14 with an inner filter straw inside the mixing rod/pipe, he can immediately start to drink from the fruit through the rod/pipe, which can act essentially as a straw. Otherwise, the user can remove the juicing tree and insert a straw; or pour the juice into a glass or the like.

Upon choosing a particular fruit or vegetable to be processed and/or upon the desired objective of the processing, the most suitable modus operandi for the juicing device of the invention can be selected. The exemplary modes provided herein are not intended to limit possible operations of the invention but rather are to exemplify some of the options for practicing and carrying out the invention.

A first modus can be implemented to produce a relatively clear juice, without a substantial portion of the pulp therein. The first modus may be characterized by formation of a drain aperture, typically at the bottom of the fruit. The fruit is then placed onto fruit holder 112 so that the drain aperture is aligned substantially coaxially with the drain aperture of fruit holder 112. Descending mechanism 106 is subsequently actuated and consequently juicing tree 14 is introduced into the fruit's interior, so that branches 1z are urged through fruit's peel and while cutting elements cut therethrough. Thereupon, the strings of branches 1z are bent upwards and towards of shaft 2 while penetrating through fruit's peel and subsequent to that are straightened out when they have penetrated therethroughout and assume substantially the conformation as shown in FIG. 19. The top portion of the fruit or the protuberance may be pierced or removed prior to the processing of the fruit, for a more convenient introduction of the juicing tree assembly thereto. Alternatively or additionally, in order to facilitate an ease of introduction, tip 18 of juicing tree 14 can be formed in a pointed or sharp shape, as shown in FIG. 16 for example.

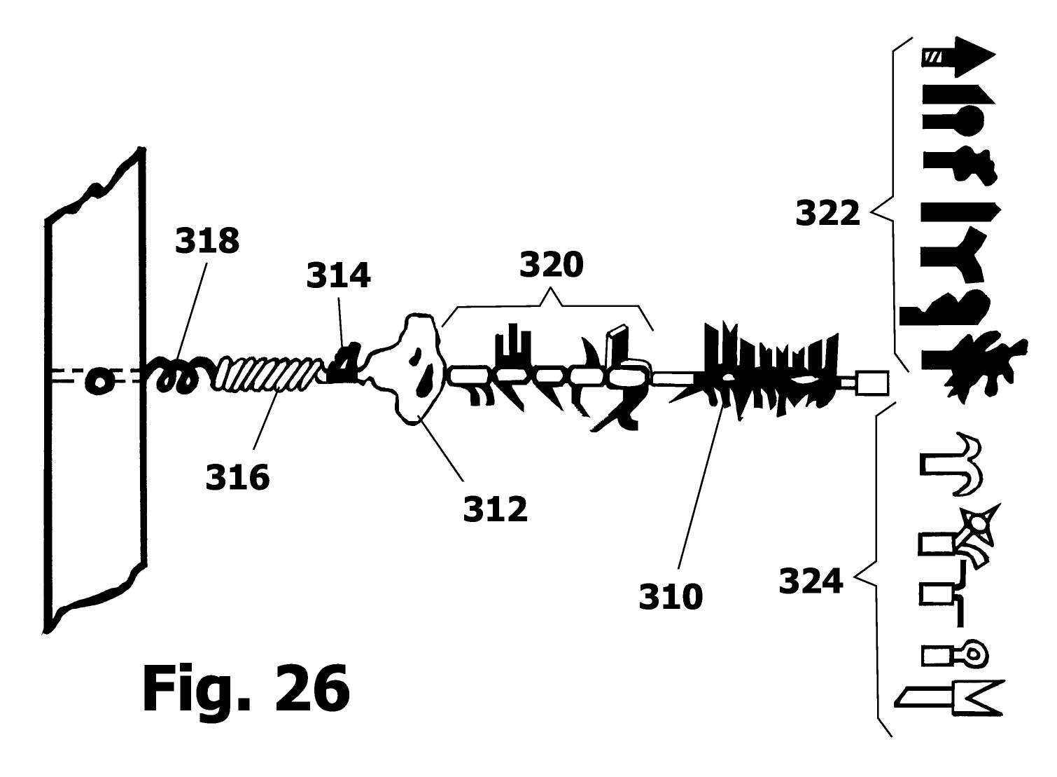

FIG. 26 shows juicing tree 14 comprising string-like branches similar to those of FIGS. 11 and 16-18, however onto which cutting tools are threaded; and including at least one weight 300, for centrifugal advantage; and a net 301 which can be useful to keep/collect seeds.

The juicer can be used even with fruits like melon, wherein the user first inserts a small juicing element to mix/release only the seeds (i.e. appropriately sized) and makes an opening (e.g. on the opposite side of entry) to expel seeds and inserts and uses the juicer. For fruits like mangoes, the user first pits the mango with a pitting machine, and then uses the instant juicer.

It should be emphasized that the flexible branches 1z of the present juicer are not merely flexible at their ends, such as disclosed in US 2009/162,508 (Davies), which are designed to merely avoid damaging the rind; rather the flexible branches are designed with so they can flex in order to enter a small hole in the rind and thus the juicer does not need any mechanism for “expanding” or deploying the branches after insertion.

Each branch 1z can be one or more thin flexible line/rod/wire [and flexibility can be throughout the length rod, or at one or more certain locations, e.g. via spaces between tools, or via one or more spring or an segment of small diameter; or a plastic manufacturing process whereby certain portion(s) have lower density.

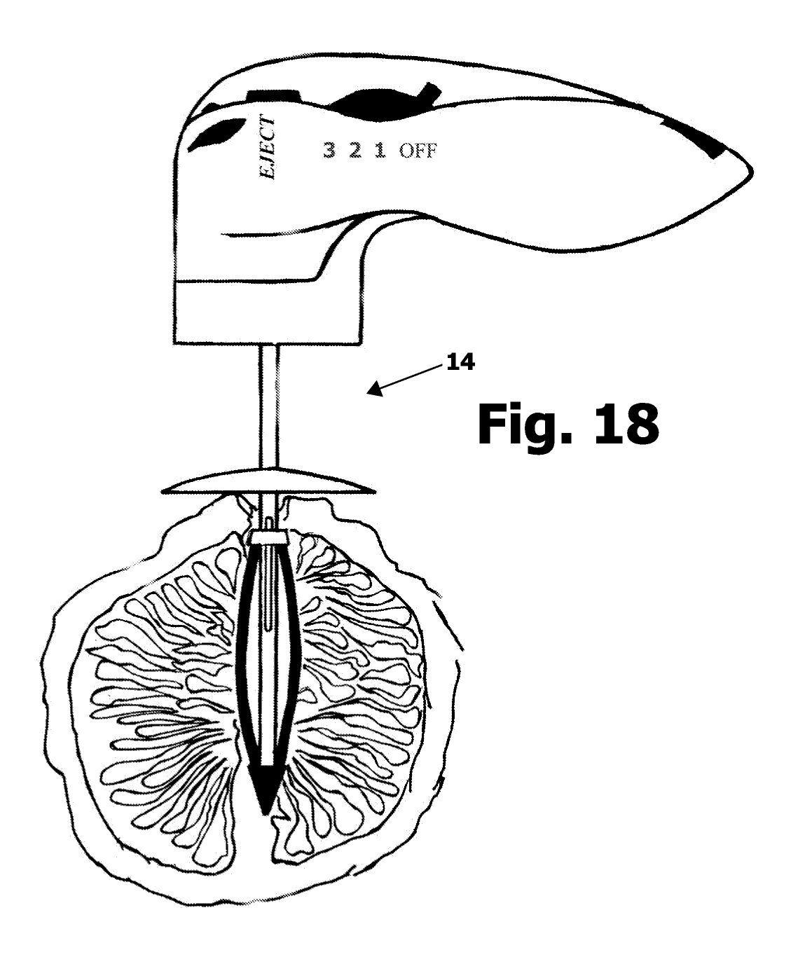

Branches 1z can alternatively be one or more flexible loops (strings/wires) that open up due to centrifugal force (see FIGS. 18 and 36) where the loop has cutting/mixing tools and/or weights. It should be emphasized that the flexible branches simply the “insertion” process and preclude a deployment mechanism that commonly requires pivots etc; and furthermore, this allows multiple branches to be used which improves the juicing.

The branches 1z: can have various shaped flesh cutting tools integral/attached and various profiles; can extend out at different angles and more than one branch can extend out from the same point on the mixing rod; can extend out of the distal end of mixing rod; can be of different lengths; can include a net to collect seeds; and can have one or more extensions (i.e. multi-branching branch configuration).

The mixing rod/shaft and wire(s) in particular, can be designed and adjusted to suit virtually almost any fruit, and the rod and wire(s) can have a wide variation of shapes, structures, types, materials, cross-sections, sizes, geometries, locations (i.e. where the wires are attached to the mixing rod), and combinations thereof. Furthermore, the juicer can also be used for juicing the contents of appropriate vegetables.

Regarding attaching branches 1z to shaft 2: (a) branches can be inserted into holes in the mixing shaft; (b) branches attached to rings (or integral with the rings; or attached with a screw) spaced along the mixing shaft; and (c) branches can be welded or adhesively attached to the shaft.

The mixing rod/shaft can be: stiff; have one or more flexible portions to allow “bending”/angling—e.g. with a spring or any other flexible element; can have a temperature measurement element (e.g. thermocouple 400) providing feedback to control the mixing rod's rotary speed (or even stop the rotation) to prevent/limit harm to enzymes, etc.; can be adapted for use as a straw (which can have different sized holes for filtering for seeds/pulp, which can branch to allow drinking from two or more fruits simultaneously or be attachable to a branching straw); can include a peel plug/cork to prevent leakage during operation/drinking or transporting; and can have a spring to allow it to be compressed (FIG. 34).

The control system or control and drive unit 20A can have memory for various juicing “cycles/programs” for various fruits in order to produce the desired juice (i.e. with lots of pulp or not—control the level of pulp); can control the direction of spin, which may help juice more juice; and can be used to control the maximum temperature of the juice in order to preserve enzymes and vitamins.

FIG. 26 shows an embodiment of juicing tree 14, in particular shaft 2 thereof illustrating numerous exemplary cutting tools and accessories affixed thereto for example, pulp filter 310; wing 312; loop 314; compressed spring 316; expanded spring 318; and slicing elements 322. Also shown are exemplary distal end elements 322 and 324 which can be incorporated in branches 1z.

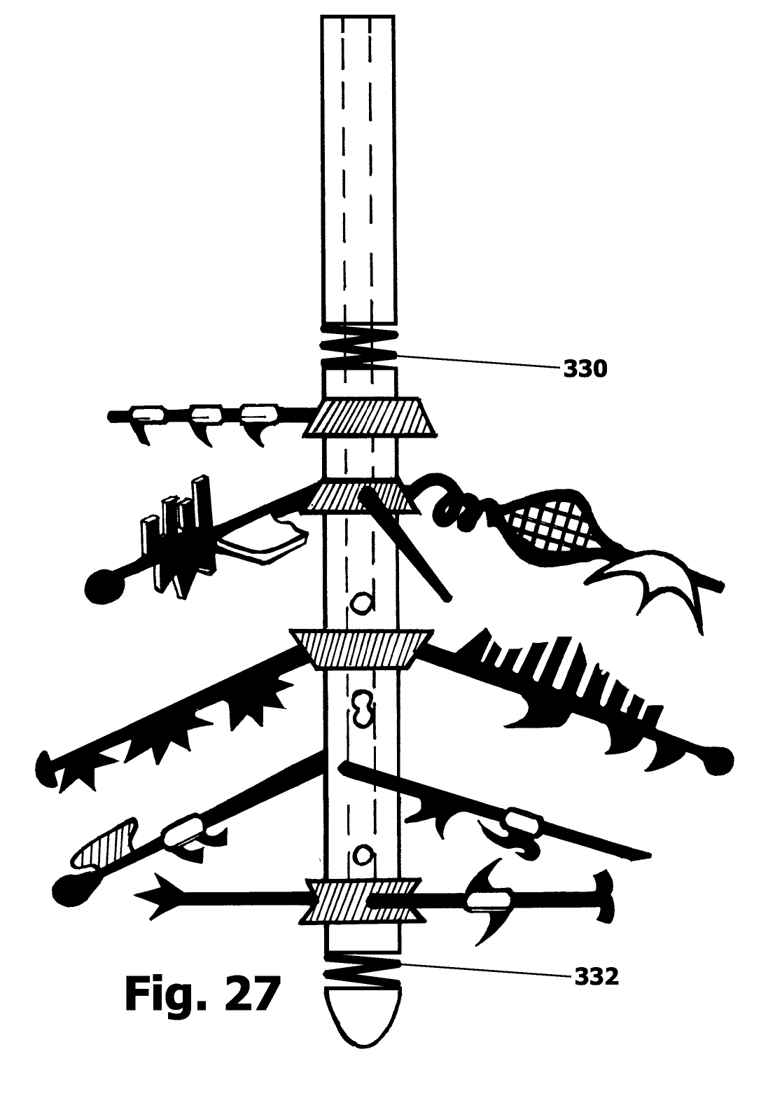

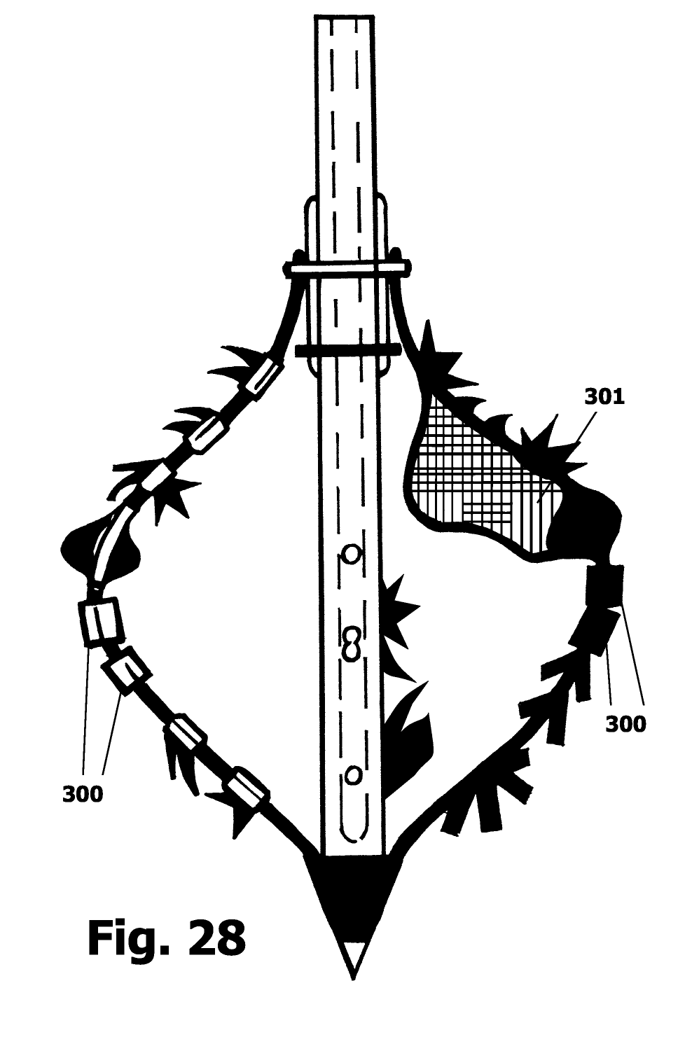

FIGS. 27 and 28 show juicing tree 14 illustrating numerous examples of branches 1z and cutting tools affixed to or part thereof. In addition, there is shown a pair of springs, upper spring 330 and lower spring 332 of shaft 2 which can provide absorption of force when the juicing tree 14 has been inserted into the fruit, to help prevent damage to the fruit.

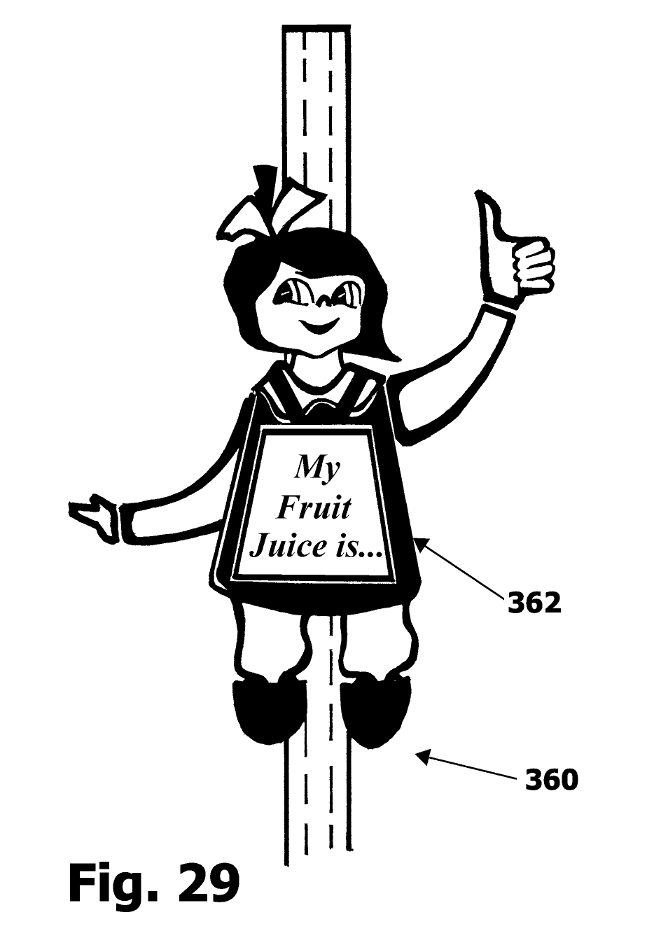

FIG. 29 shows an accessory usable with the juicer, e.g. as part of a kit; in particular a straw extension 360, including an ornamental piece or advertising portion 362.

It should be understood that the juicer and processing can be adapted, mutatis mutandis, for industrial scale production of juice (processing of fruits and vegetables). This may entail use of biological or chemical inhibitors, as known, to prevent the activity of enzymes that render the fruit or vegetable juice bitter.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A juicer for juicing, the juicer comprising:
a motor for providing a source of rotary motion; and
a juicing tree insertable into a fruit or into a mixing container, the juicing tree comprising:
a rotatable shaft, operably couple-able to the motor;
at least one flexible juicing branch, extending from the shaft; and
at least one cutting tool disposed along the shaft or along the at least one flexible juicing branch.

2. The juicer according to claim 1, further comprising a temperature measurement mechanism for measuring the temperature of juice being produced by the juicer.

3. The juicer according to claim 1, wherein one or more branches comprises a weight.

4. The juicer according to claim 1, wherein one or more branches of the at least one juicing branch extends out from a distal end of the rotatable shaft.

5. The juicer according to claim 1, wherein one or more branches of the at least one juicing branch is affixed to the shaft.

6. The juicer according to claim 1, wherein the juicing tree comprises three or more branches extending outward from the shaft.

7. The juicer according to claim 1, wherein the motor is a controllable motor.

8. The juicer according to claim 7, wherein the controllable motor is adapted to be automatically controlled and has associated therewith a processor/controller to control the rate of rotation of the shaft.

9. The juicer according to claim 1, wherein the shaft comprises a filter.

10. A juicing tree for use in combination with a motor providing a source of rotary motion, the juicing tree comprising:
a rotatable shaft, operably couple-able to the motor;
at least one flexible juicing branch, extending from the shaft; and
at least one cutting tool disposed along the shaft or along the at least one flexible juicing branch.

11. The juicing tree according to claim 10, wherein it comprises at least three branches.

12. The juicing tree according to claim 10, comprising branches at a plurality of levels or layers.

13. The juicing tree according to claim 10, further comprising a temperature measurement element.

14. The juicing tree according to claim 10, wherein one or more branches comprises a weight.

15. A juicing kit comprising:
a source of rotary motion;
a flexible juicing tree operably connectable to the source of rotary motion; and
any one or more items, or combination thereof, from the group consisting of: a straw; a container for receiving a fruit or other juice-able material; a fruit plug; and a corer or pit remover.

16. The juicing kit of claim 15, wherein the straw comprises a plurality of straw branches.
